(19) United States
(12) Patent Application Publication
(10) Pub. No.: US 2005/0109619 A1
(43) Pub. Date: May 26, 2005

(54) Gas Sensor

(75) Inventors: Shohei Yosiyasu, Nagoya-shi (JP); Makoto Hirasawa, Kasugai-shi (JP)

Correspondence Address: SUGHRUE MION, PLLC, 2100 PENNSYLVANIA AVENUE, N.W., SUITE 800, WASHINGTON, DC, 20037, US

(73) Assignee: NGK SPARK PLUG CO., LTD.

(21) Appl. No.: 10/988,608

(22) Filed: Nov. 16, 2004

(30) Foreign Application Priority Data
Nov. 17, 2003 (JP) P. 2003-387218

(51) Int. Cl. G01N 27/26

(52) U.S. Cl. 204/424

(57) ABSTRACT

A terminal fitting has a conductive portion formed into a cylinder shape and provided with a cut opening on its own side portion and along an axial direction. The conductive portion is further provided with heater pushing portions formed across the axis and in a direction joining the opening and the opposite side, as viewed in the axial direction, so as to push a heater inserted therein, onto the inner wall face of the hollow portion of an element. The left and right side end portions across the cut opening in the terminal fitting are formed into continuous corrugations of a ridge and a recess, and are made generally transversely symmetric across the opening.

### BACKGROUND OF THE INVENTION

1. Field of the Invention

The present invention relates to a gas sensor such as an oxygen sensor for detecting the oxygen concentration in a gas to be measured such as the exhaust gas discharged from an internal combustion engine and, more particularly, to a gas sensor having a heater arranged in a detecting element for heating the detecting element to an active temperature within a short time period.

2. Description of the Related Art

An oxygen sensor representing the gas sensor of this kind includes: a detecting element (as will be shortly called the “element”) of a hollow cylinder shape (or a cylindrical shape) having a leading end closed and provided with electrode layers individually on its inner and outer faces; and a fitting body (or called the “main fitting”) holding the detecting element therein and attached to the exhaust gas pipe. This oxygen sensor is employed to detect the oxygen concentration in the exhaust gas thereby to control the air/fuel ratio, by mounting it on the exhaust gas pipe of the internal combustion engine through the fitting body, by exposing the electrode layer (or the reference electrode layer) of the inner wall face (or the inner face) of the element to a reference gas (or the atmosphere) and the electrode layer (or the measurement electrode layer) of the outer wall face (or the outer face) to the exhaust gas, by generating an electromotive force between the two electrodes in a manner to correspond to the oxygen concentration difference between the inner and outer faces of the element, and by outputting a signal based on that electromotive force to a control circuit.

In some oxygen sensor, a rod-shaped (or stem-shaped) heater 61 is fitted in the hollow portion of a detecting element 21, as shown in FIGS. 12A, 12B and 12C, so as to heat the detecting element 21. FIG. 12A is a partially sectional side elevation showing the positional relations in the sensor among the element 21, a terminal fitting 71 and the heater 61; FIG. 12B is a partially-sectional right side elevation of FIG. 12A; and FIG. 12C is a section taken along line C-C of FIG. 12B. Moreover, this oxygen sensor is constructed such that the heater 61 is pushed onto the inner wall face (or the inner face) of that hollow portion (as referred to JP-A-2001-066281, for example). However, this heater 61 is inserted through the inside of a cylindrical conductive portion 73 in the terminal fitting 71 to be connected with the (not-shown) electrode layer of the inner wall face 22 of the hollow portion of the element 21, and is pushed together with the terminal fitting 71 and arranged in the hollow portion of the detecting element 21. Here, the conductive portion 73 of the terminal fitting 71 is pushed onto the electrode layer of the inner face by its own spring property and is conducted to the electrode layer. The terminal fitting 71 including the conductive portion 73 is prepared by punching out a metal sheet having the spring property and by bending it. The conductive portion 73 is formed into a cylindrical shape (or an annular shape) having a cut opening M in its side portion, and has its external diameter larger in a free state than the internal diameter of the hollow portion of the element 21 at the position of the electrode layer.

This conductive portion 73 is provided with heater pushing portions 88 which are formed to push the heater 61 onto the inner wall face 22 of the hollow portion, the heater pushing portions 88 being at a deer position than an end portion of the cylindrical conductive portion that is positioned adjacent to a deep side (i.e., on the lower side of FIGS. 12A and 12B) of the hollow portion. These heater pushing portions 88 are deformed toward the opposite side of the cut opening M across an axis G, as the conductive portion 73 is viewed in the direction of the axis G, together with the conductive portion 73 at the time when the terminal fitting 71 is pushed onto the inner side of the conductive portion 73 through the heater 61 into the hollow portion of the element 21. These deformations push the heater 61 in the same direction (i.e., in the direction of arrow A of FIG. 12B). Specifically, these heater pushing portions 88 are formed on the lower side of the conductive portion 73 across the opening M and are individually made to have a shape of a one-quarter arc having a smaller diameter than that of the conductive portion 73, for example, as viewed in the direction of the axis G, so that they form a semicircular shape together across the opening M. Thus, the heater 61 having been inserted through the conductive portion 73 is positioned on the inner side of the semicircular portion, and the conductive portion 73 is pushed into the hollow portion of the element 21. In this state, the heater 61 is transversely pushed to the opposite side of the cut opening M and onto one side (i.e., on the right side of FIG. 12A) of the inner wall face 22 of the hollow portion.

In the terminal fitting 71 used in the oxygen sensor of the related art, two side end portions 78 confronting each other across the cut opening M in the conductive portion 73 to be connected with the electrode layer of the inner face 22 of the element 21 are formed into a straight shape in the direction along the axis G, as disclosed in JP-A-2001-066281. When the terminal fitting 71 is to be inserted into the hollow portion T of the element 21, therefore, the cut opening M is deformed to close, and the diameter between the opening M and the portions 73c confronting the former across the axis G, as viewed in the direction of the axis G, is deformed to be diametrally reduced. Here, the terminal fitting 71 is formed to have such a strong spring property as to retain the reliable conduction to the electrode layer and to push the heater 61 transversely without fail. Therefore, a considerable load has to be applied for pushing the terminal fitting 71. The conductive portion 73 thus pushed is made to contact with the inner wall face 22 of the hollow portion, as viewed in the direction of the axis, by the so-called “three-point contact” among the outer circumference 73a close to the two side end portions 78 across the cut opening M and the outer circumferences 73c confronting the opening M across the axis G, as shown in FIG. 12C.

In the aforementioned sensor of JP-A-2001-066281, the two side end portions 78 are formed in the straight shape across the cut opening M in the conductive portion 73 of the terminal fitting 71. When the terminal fitting 71 is pushed into the hollow portion of the element 21, the outer circumferences 73a, as is close to the two side end portions 78, of the outer circumference of the conductive portion 73 are pushed while keeping contact with the inner wall face 22 of the hollow portion. In other words, the portions of the conductive portion 73 close to the opening M are pushed such that the outer circumferences 78a keep contact with the inner wall face 22 of the element 21. Therefore, the resistance to the push is so high as to require a high pushing force. As a result, there arises a problem that the state of the element 21 in the heater 61 to contact with the inner wall face 22 is liable to disperse. The reason for this problem is explained in the following. If the resistance to the push of the terminal fitting 71 is high, the heater 61 arranged in and inserted together with the terminal fitting 71 is easily dislocated or inclined in the hollow portion of the detecting element 21, so that the heater 61 hardly makes correct or transverse contact, as designed, with the inner wall face of the element 21. As a result, the sensor of JP-A-2001-066281 may have dispersions in the temperature rising performance of the element.

In order to make the high pushing force unnecessary, on the other hand, as described in JP-A-2000-046787, it is conceivable to form the two left and right side end portions (i.e., the side end portions 78 of FIG. 12) across the cut opening in the conductive portion of the terminal fitting into staggered (asymmetric) corrugations. In the pushing operation, the outer circumferences in the two side end portions across the cut opening are straight as in the side end portions of the conductive portion in the sensor of the aforementioned JP-A-2001-066281 so that they do not continue the contact over a large width. Therefore, the entire contact area for the inner wall face of the element can be reduced to lower the pushing force. Thus, the ridges of the corrugations in the side end portions confronting across the opening make transversely alternate contacts across the cut opening. Although the initial load is high at the push starting time, therefore, the contact area can be reduced to lower the maximum necessary pushing force.

However, it has been found that the construction has the following problems in the pushing procedure, as reasoned in the following. When the ridges on one of the side end portions confronting each other across the cut opening begin to enter the hollow portion from the open end of the detecting element, not the ridges but the recesses begin, at the confronting portion of the other side end portion, to enter the hollow portion from the open end. At the beginning of this entrance, therefore, the resistance to the passage of the recesses on the latter or other side end portion is lower than that to the passage of the ridges on the former or one side end portion. At this time, therefore, the conductive portion is inclined to that side of the other side end portion (i.e., the side of the recesses), which has a lower resistance to the push into the opening. When this push continues, moreover, the conductive portion is then inclined backward of the former. In the conductive portion where the two left and right side end portions across the cut opening are thus formed into the staggered (or asymmetrical) corrugations, the conductive portion is inserted in the pushing procedure while being alternately deviated leftward and rightward in a manner to correspond to the corrugations of the two side end portions across the cut opening M. At the push completing time, therefore, the conductive portion is slightly inclined leftward and rightward in the hollow portion.

At the push completing time of the conductive portion, on the other hand, the heater, which has been inserted into the conductive portion, is pushed by the heater pushing portions connected with the conductive portion onto the inner wall face of the hollow portion in the direction joining the cut opening and the opposite side across the axis, as viewed in the axial direction. If the conductive portion is then inclined, although slightly, transversely across the opening, the proper elastic force (or the elastic restoration) is not exhibited by the heater pushing portions so that the heater is not correctly pushed on the designed one side of the inner wall face of the element. This results in a problem that the temperature rising rate of the element disperses.

### SUMMARY OF THE INVENTION

The invention has been conceived in view of those problems and has an object to provide a gas sensor, in which a heater is pushed in a direction to intersect with the center axis of a hollow portion, when the conductive portion of a terminal fitting is to be pushed into the hollow portion of the element, with neither inviting an increase in the pushing force nor inclining the conductive portion across a cut opening after-pushed in.

According to a first aspect of the invention, there is provided a gas sensor comprising: a detecting element having a hollow cylinder shape including a closed leading end, the detecting element including a hollow portion and an electrode layer on an inner wall face of at least the hollow portion; a terminal fitting including a cylindrical conductive portion, wherein the cylindrical conductive portion is arranged in the hollow portion, when being pushed into the hollow portion, to be electrically connected with the electrode layer; and a rod-shaped heater for heating the detecting element, the rod-shaped heater being arranged in the hollow portion through the inside of the cylindrical conductive portion, wherein the cylindrical conductive portion of the terminal fitting has a cylindrical shape, in which the cylindrical shape has a cut opening in a side portion of the cylindrical shape, the cut opening being along an axial direction of the conductive portion, and wherein the cylindrical conductive portion of the terminal fitting comprises at least one heater pushing portion for pushing the rod-shaped heater in a direction to intersect with a center axis of the hollow portion, the said at least one heater pushing portion being at a deeper position than an end portion of the cylindrical conductive portion that is positioned adjacent to a deep side of the hollow portion, and wherein the terminal fitting comprises left and right side end portions across the cut opening, in which the left and right side end portions comprise respective corrugations having at least one recess and at least one ridge at each of the left and right side end portions, the corrugations being provided generally symmetrically transversely across the cut opening.

According to a second aspect of the invention, there is provided a gas sensor as set forth in the first aspect of the invention, wherein said at least one heater pushing portion is provided to push the rod-shaped heater onto an inner wall face of the detecting element in a direction joining the cut opening and the opposite side across the center axis, as viewed in an center axial direction of the hollow portion.

According to a third aspect of the invention, there is provided a gas sensor as set forth in the first or second aspect of the invention, wherein each of ridges of the corrugations comprises a crest having an arcuate shape.

According to a fourth aspect of the invention, there is provided a gas sensor as set forth in any of the first to third aspects of the invention, wherein the terminal fitting comprises such a notch on a side opposite to the cut-opening across the center axis, as viewed in an axial direction of the hollow portion, as is cut from an end side positioned on the deep side of the hollow portion, and wherein the notch has a substantially constant width toward an rear end side, the rear end side being opposite to the deep side, and has a bottom recessed into one of a U-shape and an arcuate shape.

According to a fifth aspect of the invention, there is provided a gas sensor as set forth in any of the first to third aspects of the invention, wherein the terminal fitting comprises such a notch on a side opposite to the cut opening across the center axis, as viewed in an axial direction of the hollow portion, as is cut from an end side positioned on the deep side of the hollow portion, and wherein the notch comprise a portion diametrally reduced toward an rear end side, the rear end side being opposite to the deep side.

According to a sixth aspect of the invention, there is provided a gas sensor as set forth in any of the first to fifth aspects of the invention, wherein the cylindrical shape of the conductive portion is formed by bending a metal sheet having a spring property.

### BRIEF DESCRIPTION OF THE DRAWINGS

FIG. 1 presents a longitudinally sectional front elevation and a partially omitted, partially enlarged view of an essential portion for explaining the best mode for carrying out a gas sensor of the invention;

FIG. 2 is a development of a terminal fitting used in the gas sensor of FIG. 1 before it is bent;

FIG. 3A is a view, as taken from the left side of FIG. 1, of the terminal fitting 71 used in the gas sensor of FIG. 1;

FIG. 3B is a view of FIG. 3A taken from the back side;

FIG. 4A is a explanatory view (sectional views perpendicular to the axis) showing a state in which the conductive portion of the terminal fitting is to be pushed into the hollow portion of an element, and taken from the trailing end side of the element along the axis, the view being before pushed;

FIG. 4B is a explanatory view (a section taken normal to the axis) showing a state in which the conductive portion of the terminal fitting is to be pushed into the hollow portion of an element, and taken from the trailing end side of the element along the axis, the view being after pushed;

FIG. 5A is a view showing the arranged relations exaggeratedly among the conductive portions, the guide portions, the heater pushing portions and the heater when the terminal fittings and the heater are taken in the axial direction, the view being before pushed into the element;

FIG. 5B is a view showing the arranged relations exaggeratedly among the conductive portions, the guide portions, the heater pushing portions and the heater when the terminal fittings and the heater are taken in the axial direction, the view being after pushed into the element;

FIG. 6A presents explanatory diagrams at the time when the heater pushing portions or the like of the terminal fitting begin together with the heater to enter the hollow portion of the element;

FIG. 6B presents explanatory diagrams at the time when the heater pushing portions or the like of the terminal fitting are pushed into the hollow portion of the element;

FIG. 7 is a longitudinally sectional front elevation for explaining the procedure of assembling the gas sensor;

FIG. 8 is a diagram for explaining the change in the load (or the inserting load) required for pushing the terminal fitting;

FIG. 9 is a back elevation of a terminal fitting of another embodiment, in which the notches are modified in shape;

FIG. 10 is a section taken normal to the axis for explaining the state, in which the terminal fitting of FIG. 9 is deformed on the V-shaped groove bottom of the notches;

FIG. 11 is an explanatory view of the heater pushing portions, as taken in the axial direction, of one example of the terminal fitting which can grip the heater; and

FIGS. 12A, 12B and 12C are sections for explaining the oxygen sensor of the related art in the state where the heater is fitted in the hollow portion of the detecting element.

### DETAILED DESCRIPTION OF THE INVENTION

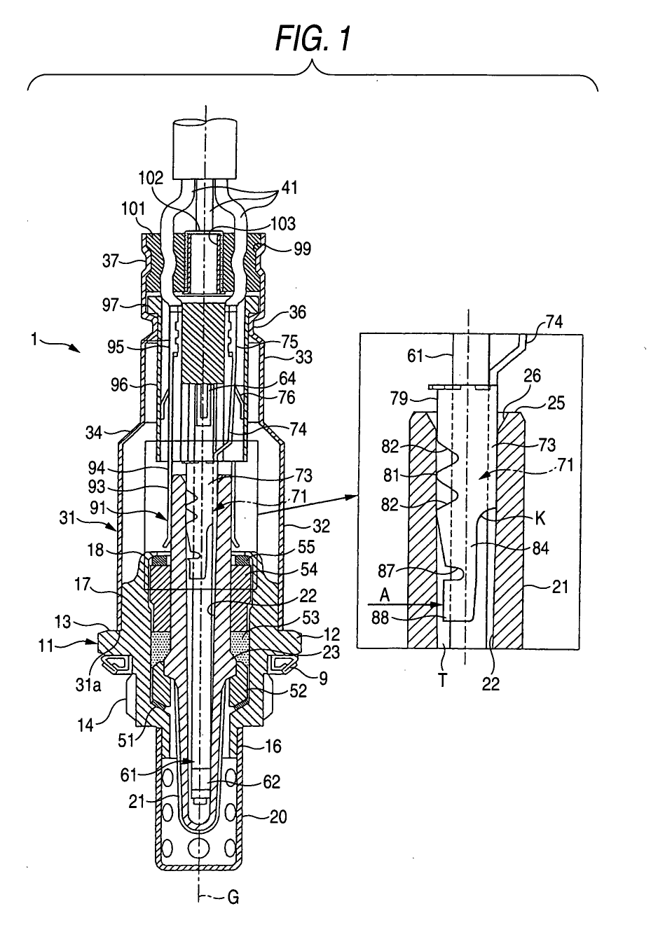

The best mode for carrying out the invention will be described in detail with reference to FIGS. 1 to 7. In FIGS. 1 to 7, reference numeral 1 designates an oxygen sensor, in which a cylindrical (or a hollow cylinder shape) detecting element 21 (as will also be shortly called as the “element 21”) having (not-shown) electrode layers on the inner and outer wall faces and having a closed end is fixed gas-tight on the inner side of a stepped cylindrical fitting body 11 (as will also be shortly called as the “body 11”). The element 21 is provided at its middle portion with a diametrally larger portion 23 having a constant width and protrudes at its leading end from the leading end of the fitting body 11. This element 21 is fixed gas-tight in the fitting body 11 by arranging an insulating ring 52 through a washer 51 on the stepped portion of the inner side of the fitting body 11, by causing the recess of the inner circumference edge, as located in the upper portion, of the insulating ring 52 to receive that diametrally larger portion the (not-shown) leaf packing, and by interposing a sealing member (of talc) 53, a pushing ring 54 and so on to compress the sealing member 53.

This fixing operation is carried out by arranging a flat washer 55 at the trailing end of the pushing ring 54 and by bending the end portion of a thin-walled cylindrical portion 18 at the trailing end of the body 11 inward to caulk and compress it on the leading end side. The body 11 is integrally provided on the outer circumference of its shown vertically intermediate portion with a screw-in polygonal portion 12 and on its leading end side with a threaded portion 14 to be screwed in the exhaust pipe and a diametrally smaller cylindrical portion 16 sequentially in the recited order. To the diametrally smaller portion 16, there is attached a protective cover 20 which has vent holes for protecting the protruding leading end of the element 21. The body 11 is provided with a thick-walled cylindrical portion 17 between the polygonal portion 12 and the thin-walled cylindrical portion 18 at the trailing end. A protective cylinder 31 acting as the later-described casing is mounted on the thick-walled cylindrical portion 17 and is laser-welded all over its circumference in the state where the leading end face 31a of the protective cylinder 31 is held to abut against the trailing end side flange face 13 of the screw-in polygonal portion 12. A sealing washer 9 is fitted between the screw-in polygonal portion 12 and the threaded portion 14 of the body.

On the other hand, a hollow portion T inside of the detecting element 21 is formed in such a tapered shape and in alignment with the axis G of the body 11 as has a circular transverse section slightly reduced in diameter toward the leading end. The trailing end 25 of the detecting element 21 is chamfered, as indicated by 26, at the corner close to the hollow portion. In the hollow portion T, moreover, there is fitted a heater 61 which has a rod shape (or a stem shape) having a circular section for heating the detecting element 21. Moreover, the heater 61 is pushed, as indicated by an arrow A in the enlarged view of FIG. 1, onto one side (i.e., onto the right side of FIG. 1) of the inner face (i.e., the inner wall face of the hollow portion) 22 of the element 21, as will be described hereinafter. This heater 61 is arranged in the hollow portion T of the detecting element 21 through the inner side of a cylindrical conductive portion 73 in a terminal fitting (as will also be called the “inner face terminal fitting) 71, which makes the gist of the invention. This inner face terminal fitting 71 will be described in detail hereinafter. A conductive portion 93 of another terminal fitting (as will also be called the “outer face terminal fitting) 91 is fitted on the electrode layer which is formed on the outer face (or the outer side) of the element 21. On the cylindrical portions of the individual terminal fittings 71 and 91, there are extended lead wire portions 74 and 94, which are individually connected at their end connector portions 75 and 95 with lead wires 41.

The individual lead wires 41 are threaded through the individual wiring holes formed in a separator 96 made of an electrically insulating material such as alumina and through the individual wiring holes formed in a sealing member 99 arranged at the trailing end of the oxygen sensor and are led out from the trailing end portion 101 of the sealing member 99. Here, both the separator 96 and the sealing member 99 are formed into a generally column-shaped or cylindrical shape, and the individual wiring holes (at four portions) are formed at an interval of an equal angle (or 90 degrees) on one circumference, as viewed in the direction of the axis G. From the whole circumference of the upper end portion of the separator 96, there is protruded a flange 97, which is received by ridges 36 formed intermittently on the inner side of the upper portion of the protective cylinder 31. In the center of the lower face of the separator 96, there is formed the bore which can insert the portion of the heater 61 close to the trailing end. Here, the heater bore is so cut in the circumference closer to the axes of the wiring holes that the portion closer to the lower face when the separator 96 is viewed upward, as exhibits a cross-shaped bore.

On the other hand, the heater 61 is provided on one side (on the right side of FIG. 1) of its leading end portion (i.e., its lower end portion of FIG. 1) with a heating portion 62 and on the side face of its trailing end portion with a pair of terminals 64 leading to that heating portion 62. These terminals 64 are connected with the individual lead wires 41. These lead wires 41 are threaded, like the lead wires connected with the aforementioned inner side terminal fitting 71, through the wiring holes of the separator 96 and the sealing member 99 and are led out from the trailing end portion 101 of the sensor. These separator 96 and sealing member 99 are covered with the protective cylinder 31. In this embodiment, this protective cylinder 31 is formed at its about one half of the leading end side (i.e., the lower side of FIG. 1) into a diametrally larger portion 32 and at its about one half of the trailing end side into a diametrally smaller portion 33 through a tapered portion 34. The protective cylinder 31 is caulked at a portion of its diametrally smaller portion 33 to fix the sealing member 99. Here, numeral 102 in FIG. 1 designates a water-repellent air-permeable member formed into a cap shape. This member 102 is arranged in and through the sealing member 99 while being covered with a metal pipe 103, thereby to introduce the atmosphere into the element 21.

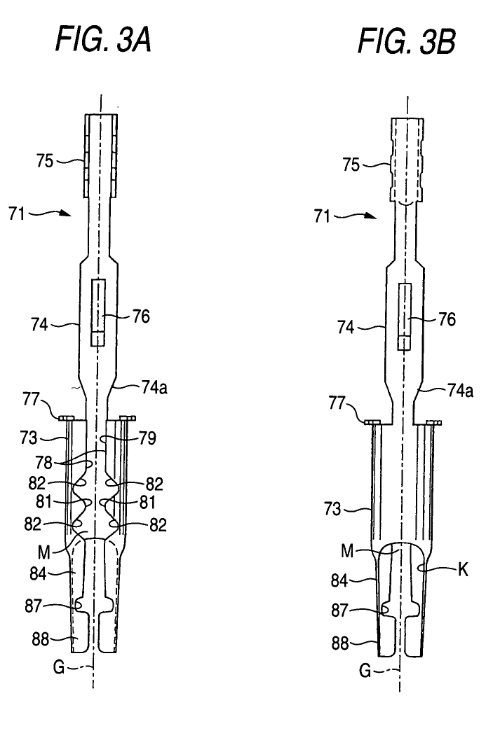

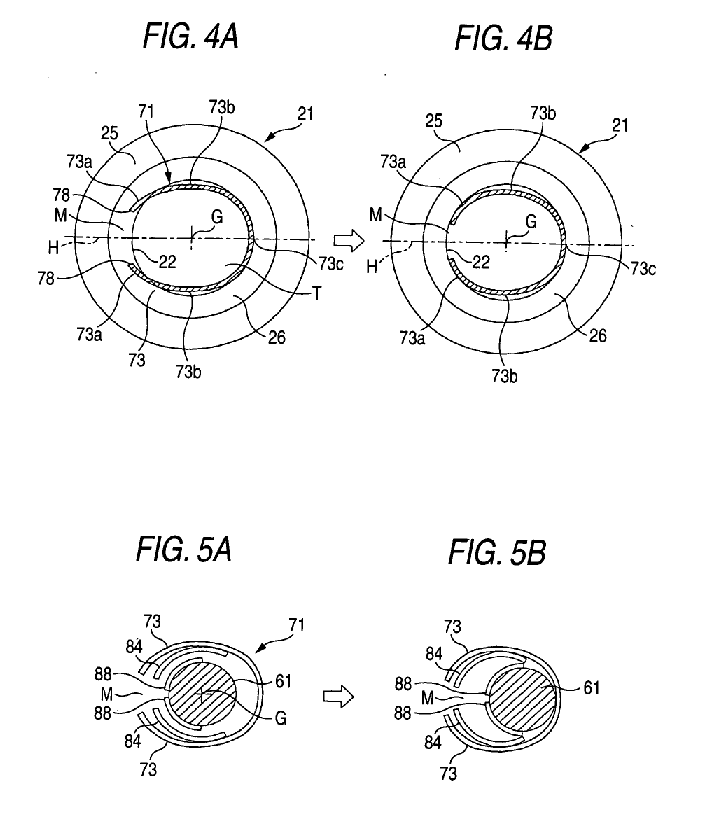

Here will be detailed the inner side terminal fitting 71 making the gist of the invention with reference to FIG. 1 to FIGS. 3A and 3B. Specifically, this terminal fitting 71 is formed into the shape, as shown in FIG. 1 and FIGS. 3A and 3B, by bending a metal sheet (of a corrosion- and heat-resistant super alloy sheet) 70 around the axis G thereby to form the shape shown in FIG. 1 and FIGS. 3A and 3B. FIG. 3A is a view showing the terminal fitting 71 on the left side of FIG. 1, and FIG. 3B is a view showing the same on the right side. This terminal fitting 71 is formed such that the conductive portion 73 has a cylindrical shape with a cut opening M in its side portion, and exhibits a general horseshoe shape, as shown in FIG. 4, when it is cut in a plane (as will also be called the “axially normal section”) normal to the center axis G. This terminal fitting 71 is so formed that the maximum external diameter of its conductive portion 73 in a free state is larger than the internal diameter of the position of the (not-shown) electrode layer in the hollow portion T of the element 21, and is so set that it is diametrally reduced in the hollow portion by the resiliency, as shown in FIG. 4A and FIG. 4B. As shown in FIG. 4A, the shape of the section, as normal to the axis, of the terminal fitting 71 including the conductive portion 73 takes as lightly modified horseshoe shape in both the free state and the set state, as will be described in more detail.

Over the conductive portion 73 and on the opposite side of the opening M across the axis G, as shown in FIG. 1 and FIGS. 3A and 3B, the leading wire portion 74 extends upward through a flexible portion 74a inclined upward, and is provided at its upper end with the connector portion 75 with pawls for caulking and connecting the cores of the lead wires 41. In this embodiment, the lead wire portion 74 is provided at its center with tongue-shaped spring members 76, which are inclined outward so that they are pushed at the setting time onto the wiring holes of the separator 96. The conductive portion 73 is provided at its upper end with a plurality of outward protruding teeth 77, which are so set that the wall ends defined by the bore at the center in the lower face of the separator 96 and by the wiring holes abut against the upper faces of the teeth 77. As a result, there are formed a pushing portion for pushing (or inserting) the terminal fitting 71 into the hollow portion of the element 1, and a stopper for preventing the excessive insertion.

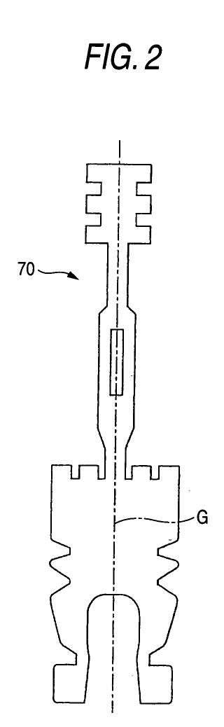

As shown in FIG. 2 and FIGS. 3A and 3B, moreover, side end portions 78 across the cut opening M of the conductive portion 73 are provided symmetrically across the opening M with straight portions 79 close to the upper ends and continuously from the straight portions 79 with saw teeth having corrugations of substantially identical triangular shapes. Specifically, these saw teeth are composed of one ridge 81 and two recesses 82 on the two sides of the ridge 81, and this ridge 81 has an arcuately rounded crest and arcuately rounded valleys. This conductive portion 73 is diametrally reduced when set in the hollow portion, as described hereinbefore, so that it is electrically connected with the electrode layer by the spring property. In the pushing procedure where the conductive portion 73 of the terminal fitting 71 is to set in the hollow portion T of the element 21, as shown in FIG. 4, the conductive portion 73 is largely reduced in the radial directions among the predetermined width portions of the outer circumferences 73a close to the two side end portions 78 across the cut opening M, the cut opening M and an outer circumference 73c on the opposite side across the axis G, as shown in FIGS. 4A and 4B and as viewed in the axial direction, so that the conductive portion 73 is strongly pushed onto the inner wall face (or the electrode layer) of the hollow portion. In the set state, specifically, the outer circumferences 73b between the outer circumferences 73a close to the side end portions 78 and the outer circumference 73c on the side opposed to the cut opening M across the axis G are set in such a horseshoe shape of the so-called“three-point contact”, as viewed in the axial direction, as to have no substantial contact with the inner wall face of the hollow portion or as to leave a minute clearance.

The conductive portion 73 is provided, transversely symmetrically across the cut opening M, with: guide portions 84 for guiding the conductive portion 73 being pushed into the hollow portion T of the element 21; and, below the guide portions 84, heater pushing portions (or push portions) 88 for pushing the side faces (as located on the left side of FIG. 1) of the heater 61 onto one side (as located on the right side of FIG. 1) of the inner wall face 22 of the hollow portion T of the element 21. Of these, the guide portions 84 are so tapered as to have their external diameter smaller than that of the conductive portion 73. Moreover, the guide portions 84 is so opened on the opposite side of the cut opening M across the axis G as to have notches K, which are cut with a substantially constant width approximate of the diameter of the conductive portion 73. In this embodiment, the trailing end sides of the notches K are formed at their bottom into recesses of a U-shape or a semicircular shape, as shown in FIG. 3B.

The heater pushing portions (or the push portions) 88 are formed symmetrically, as shown in FIGS. 3A and 3B, below the guide portions 84 and close to the two side end portions 78 on the side of the cut opening M individually through transverse cuts 87. These heater pushing portions 88 are formed, for example, into a one-quarter arc (as referred to FIGS. 5A and 5B) having a smaller diameter, as seen in the direction of the axis G, than the internal diameter of the conductive portion 73, the guide portions 84 and the opening of the hollow portion T at the trailing end 25. As seen in the axial direction, therefore, the conductive portion 73, the guide portions 84 and the heater pushing portions 88 are so relatively arranged as exaggeratedly shown in FIG. 5A before they are inserted into the hollow portion of the element 21 and as exaggeratedly shown in FIG. 5B after they were inserted. On the inner side of the conductive portion, more specifically, the heater 61 is so loosely fitted (FIG. 5A) in the conductive portion 73 before inserted into the hollow portion as to inscribe with the heater pushing portions 88, and is pushed, after inserted, onto the inner face of the conductive portion 73 by the heater pushing portions 88, as shown in FIG. 5B. The pushing direction is from the left to the right, as seen in the direction of the axis G in FIGS. 4A and 4B, along a straight line H joining the cut opening M and the opposite side across the axis G.

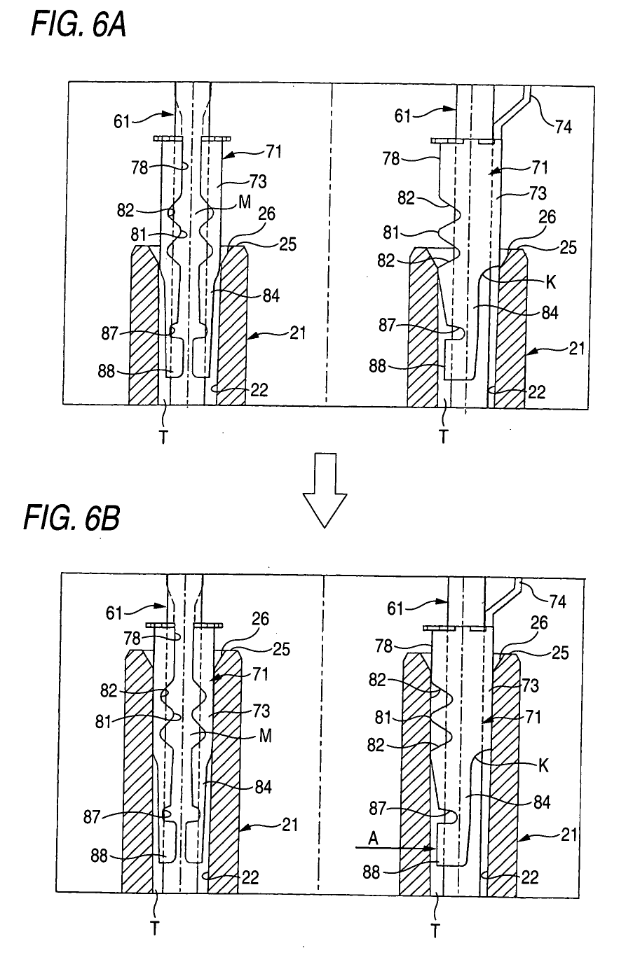

Thus in this embodiment, a loose fit is established when the heater 61 is inserted into the conductive portion 73 of the terminal fitting 71. The heater 61 is not gripped by but contacts loosely with the inner face of the heater pushing portions 88. The assembly having the heater 61 threaded in the inner side of the conductive portion 73 is positioned to have its leading end confronting the trailing end of the hollow portion T of the element 21 (or the trailing end of the opening). Then, the heater 61 enters the hollow portion T of the element 21, as shown in FIG. 6A, so that the heater pushing portions 88 and the guide portions 84 go without any substantial resistance. When the terminal fitting 71 is further pushed from that state into the hollow portion T, as shown in FIG. 6B, the conductive portion 73 is deformed and diametrally reduced, as described hereinbefore. Then, the heater pushing portions 88 are deformed not only according to the deformation of the conductive portion 73, as shown in FIG. 5B, but also the influences of the elastic restoration which is established by the abutment of the heater 61 against the inner wall face 22 of the element 21, thereby to push the heater 61 in the direction of arrow A in FIG. 1.

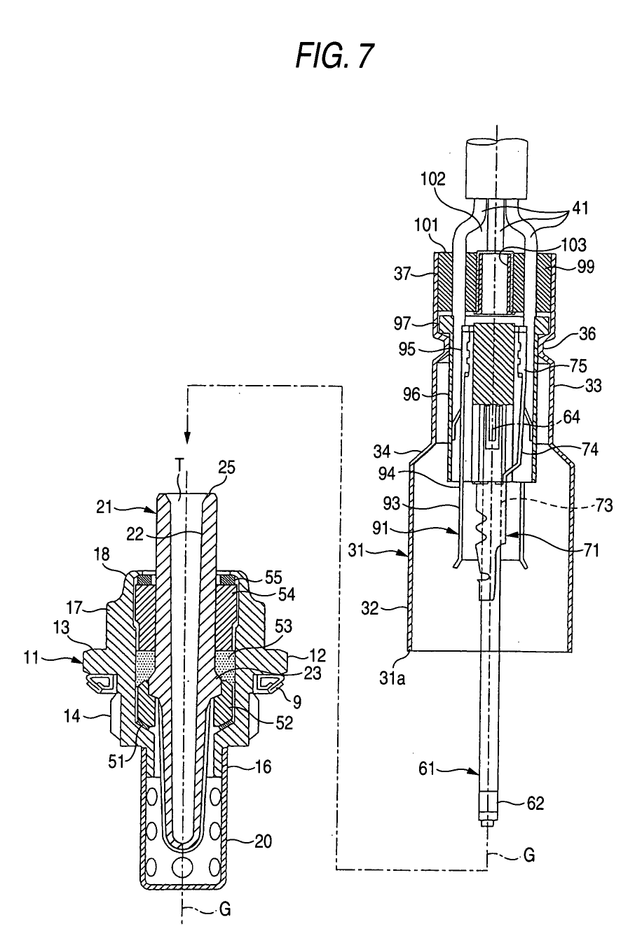

The sensor 1 thus constructed is made by assembling a subassembly, as shown on the right side of FIG. 7, when the heater 61 is to be mounted, with the hollow portion T of the detecting element 21 fixed in the fitting body 11 or the subassembly shown on the left side of FIG. 7. Specifically, the assembly including the terminal fittings 71 and 91, the heater 61 and the individual lead wires 41 is prepared by connecting the individual conductive portions 75 and 95 of the individual terminal fittings 71 and 91 to be connected with the individual electrode layers of the detecting element 21, with the lead wires 41, and by connecting the individual terminals 64 of the heater 61 and the lead wires 41. At this time, the heater 61 is inserted in advance into the inside of the conductive portion 73 of the terminal fitting 71 to be connected with the electrode layer of the inner face 22 of the detecting element 21 (i.e., into the insides of the heater pushing portions). The individual lead wires 41 are threaded through the individual wiring holes of the separator 96 and further through the individual holes of the sealing member 99. These elements are covered with the protective cylinder 31, as shown on the right side of FIG. 7.

The subassembly thus including the heater 61 is so positioned that the heater 61 may be inserted into the hollow portion T of the element 21 from the opening of the trailing end 25 of the same, and the terminal fitting 71 is brought to confront the opening of the trailing end 25 of the element 21. At this time, the aforementioned subassemblies are assembled with each other, but the hollow portion T of the element 21, and the terminal fitting 71 and the heater 61 are inserted in the positional relation shown in FIG. 6. Then, the terminal fitting 71 is pushed downward to push the conductive portion 73 into the hollow portion T. Thus, the conductive portion 73 of the terminal fitting 71 is deformed and diametrally reduced, as described hereinbefore, and is pushed onto the electrode layer of the inner face 22 of the element 21 thereby to retain the conduction between them. At the same time, the heater pushing portions 88 push the heater 61 onto the inner face 22 of the element 21, as described hereinbefore. Simultaneously with this push, the terminal fitting 91 to be connected with the electrode layer on the outer face of the element 21 is set. From now on, the oxygen sensor 1 is assembled by setting the individual members correctly in the axial direction, by fixing the protective cylinder 31 on the body 11 and by caulking the protective cylinder 31 on the outer side of the sealing member 99.

The oxygen sensor 1 thus constructed achieves the following effects at the time of pushing the terminal fitting 71 for its assembly into the hollow portion T of the element 21. Specifically, this push is performed with the heater 61 being inserted into the conductive portion 73. The heater 61 has a smaller external diameter than the internal diameter of the hollow portion T so that it can enter the hollow portion T without any problem. The conductive portion 73 of the terminal fitting 71 to be arranged in the hollow portion T begins to enter the hollow portion T while being guided by the heater pushing portions 88 and the guide portions 84. When the conductive portion 73 begins to enter, moreover, it is diametrally reduced because its external diameter (i.e., the diameter, as seen in the axial direct, between the two end portions 78 across the cut opening M and the outer circumference on the opposite side across the axis) is larger than the internal diameter of the hollow portion T. At the entrance of the hollow portion T (i.e., at the chamfered portion 26 of the trailing end 25), the conductive portion 73 begins to enter the hollow portion T while being diametrally reduced and squeezed between the outer circumferences 73a close to the two side end portions 78 across the cut opening M and the outer circumference 73c on the opposite side of the cut opening M across the axis. Specifically, the conductive portion 73 is pushed into the hollow portion T such that its three points, i.e., the outer circumferences 73a close to the two side end portions 78 across the cut opening M and the outer circumference 73c of the portion on the opposite side of the cut opening M across the axis G are strongly squeezed with the inner face 22 of the hollow portion T.

When the ridges 81 formed at the side end portions 78 in the conductive portion 73 begin during that insertion to enter the hollow portion T, they come into abutment against the trailing end 25 of the element 21 or its chamfered portion. This abutment establishes a relatively high resistance so that the load required becomes relatively high. On the other hand, the side end portions 78 on the two sides of the cut opening M are corrugated. After the ridges 81 entered the hollow portion T, therefore, the predetermined width portions close to the individual side end portions' are not pushed, unlike the terminal fitting of the related art having the two straight side end portions, such that the predetermined width portions close to the individual side end portions are pushed along the straight line with the that width while keeping contact with the inner face of the hollow portion. In this embodiment, the ridges 81 of the corrugations are pushed while contacting at the wide portions of their outer faces, but the recesses 82 are pushed by the contact of their narrow portions. Of the outer circumference of the conductive portion 73, the entire contact area close to the two side end portions 78 can be reduced to raise an effect that the maximum load necessary for the pushing operation can be reduced.

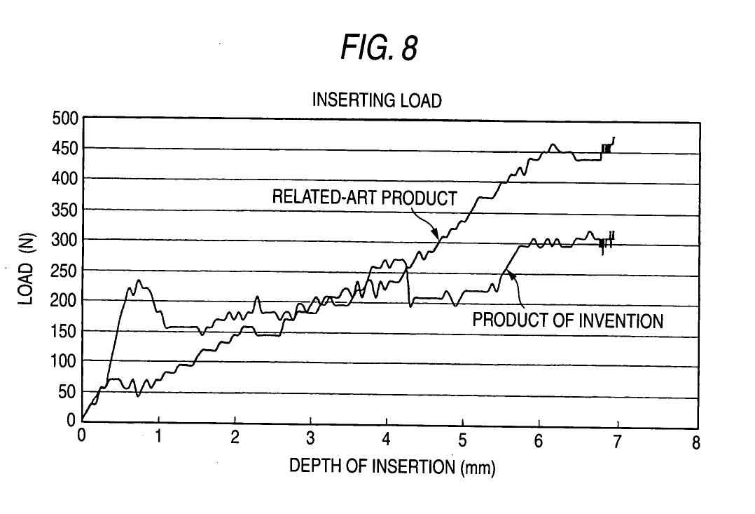

Here, the necessary loads for the depth of insertion after the displacement of the conductive portion 73 was started by inserting the terminal fitting 71 and till the insertion was completed were measured and compared between the existing gas sensor including the terminal fitting, in which the two side end portions 78 confronting each other through the cut opening M are composed of the straight conductive portion, and the gas sensor of this embodiment (product of the present invention). The results are presented in FIG. 8. As shown in FIG. 8, the inserting load was gradually increased from the start of the displacement to the end of the insertion of the conductive portion 73 in the existing gas sensor having the straight side end portions 78 so that the maximum load required was about 450 N. In the gas sensor of the invention, on the contrary, the load at the beginning time of the displacement of the conductive portion 73 was relatively high but was not seriously changed till the insertion end, and the maximum load required was satisfied by about 300 N. This verifies that the invention can reduce the force for the insertion (i.e., the maximum load) reliably.

In the embodiment thus far described, moreover, the corrugations of the side end portions 78 on the two sides of the cut opening M are made transversely symmetric across the cut opening M. In the procedure where the conductive portion 73 is pushed, therefore, the conductive portion 73 is deviated (to have behaviors) back and forth (i.e., in the transverse direction of the right diagrams of FIGS. 6A and 6B) by the corrugations, but is not leftward and rightward (i.e., in the transverse direction of the left diagrams of FIGS. 6A and 6B). After the conductive portion 73 was pushed, therefore, the conductive portion 73 can be prevented from being inclined in the transverse direction in the left diagrams of FIGS. 6A and 6B). After the push, more specifically, the heater pushing-portions 88 provided below the conductive portion 73 are not deviated in the transverse direction of the left diagrams of FIGS. 6A and 6B so that the heater 61 can be correctly pushed (i.e., transversely pushed) at its side face correctly toward the inner face 22 of the element 21. Therefore, the oxygen sensor thus assembled is attached through the fitting body 11 to the exhaust gas pipe of an internal combustion engine so that it is used for detecting the oxygen concentration in the exhaust gas thereby to control the air/fuel ratio. At this time, the heater 61 can raise the temperature of the element 21 quickly and stably thereby to stabilize the performance of the element 21.

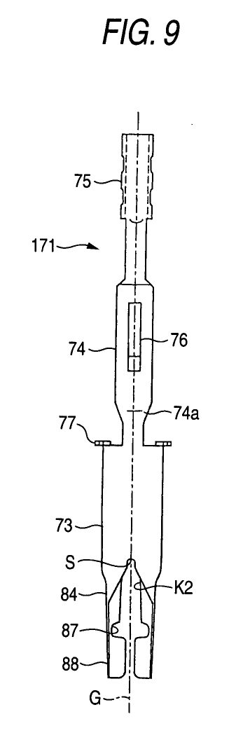

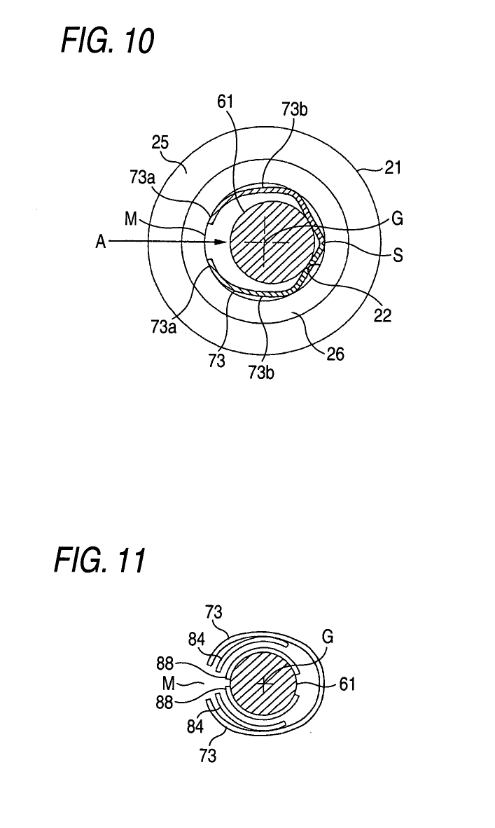

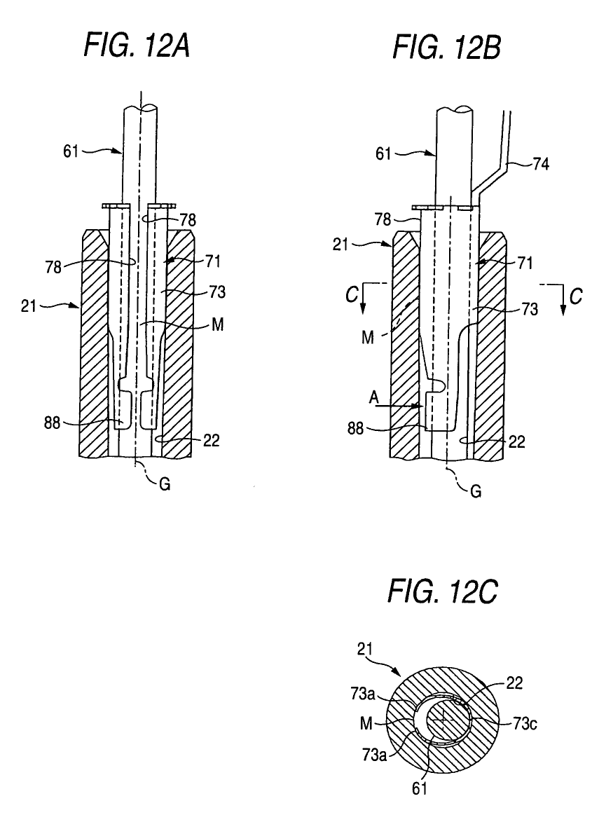

The terminal fitting 71 of this embodiment is provided with the notches K symmetrically of the axis G on the opposite side of the cut opening M across the axis G so that the heater 61 can be stably pushed in the transverse direction by the heater pushing portions 88. Moreover, this embodiment has the following effects because the notches K have their bottoms recessed into the U-shape or the arcuate shape, as shown in FIG. 3B. The notches K of the terminal fitting of the foregoing embodiment can also be replaced by notches K2 of a terminal fitting 171 shown in FIG. 9. This terminal fitting 171 is modified to have such a V-shape as is diametrally reduced-continuously toward the trailing end. With these notches K2, the resistance at the time of pushing the element into the hollow portion can be reduced to raise an effect that the pushing force is reduced or that the pushing operation is smoothed. On the contrary, the thinning of the material for the terminal fitting may invite a reduction in rigidity to cause the following problem. With the notches K2 of the V-shape having the portion in which the radius is continuously reduced toward the trailing end side, the conductive portion 73 may be either bent to close on or from a narrow groove or a V-shaped groove bottom S on the trailing end side of the notches K2, as viewed from in the direction of the axis G in FIG. 10, or so deformed that the groove bottom S protrudes outward. This bend or deformation is caused by the resistance following the push of the element 21 into the hollow portion.

The heater 61 is pushed on its one side in the direction of arrow A by the (not-shown) heater pushing portion. Moreover, the heater 61 is supported on the right side of FIG. 1 by the so-called “three-point support” of the inner faces of the conductive portion 73, as positioned at portions close to the trailing end 25 of the element 21 in the hollow portion T and the inner face of the hollow portion close to the leading end. With this deformation, therefore, on the inner face of the conductive portion 73, as shown in FIG. 5B, the heater 61 should be intrinsically pushed onto the side, as opposed to the cut opening M across the axis G, of the arcuate inner side of the conductive portion 73 thereby to make the so-called “one point contact”, but establishes the situation shown in FIG. 10. In short, the heater 61 makes such a contact in the conductive portion 73 as is received by the two sides of the deformed portion. As a result, the heater 61 is received in the conductive portion 73 at a portion spaced by the thickness or more of the conductive portion 73 from the inner face 22 of the hollow portion.

Specifically, the heater 61 is spaced the more from the inner face 22 of the element 21 as it goes the farther toward its root end (i.e., the upper end of the heater 61 of FIG. 1), thereby to cause a problem that the time period required for raising the temperature of the element 21 (i.e., the time period for the element 21 to reach a reactive temperature). Alternatively, some terminal fittings have and do not have such deformations thereby to cause dispersions in the products (i.e., the oxygen sensors). As the spacing becomes the larger, the shock resistance of the heater becomes the worse. In this embodiment, on the other hand, the notched portions K are recessed to have the U-shape or the arcuate shape. Therefore, the aforementioned deformation can be prevented to raise an effect that such problem can be eliminated.

The foregoing embodiment has been described on the case, in which the conductive portion 73 in the terminal fitting 71 is provided with the heater pushing portions 88 exclusively for pushing one side of the rod-shaped heater 61 onto the inner face of the element 21. Despite of this description, however, the actions of the heater pushing portions should not be limited to the push of one side of the rod-shaped heater 61 but may also be the push of one side of the heater 61 onto the inner face of the element after the heater was gripped. For example, the two heater pushing portions in the aforementioned terminal fitting 71 are formed into the one-half arc, as shown in FIGS. 5A and 5B. The heater pushing portions may also be modified into that shown in FIG. 11. Specifically, the two heater pushing portions 88 may be so modified into a three-quarter (or three fourths) arc, as viewed in the axial direction, as to grip the heater 61 stably. That is, the internal diameter of that arc in a free state is made smaller than the external diameter of the heater 61 so that the heater 61 may be gripped by the spring property when it is inserted into the inside of the conductive portion. According to this modification, the heater 61 is constricted in the axial direction, too, so that its position stability in the hollow portion is high.

Here, the corrugations in the side end portions 78 on the two left and right sides across the cut opening M may be transversely symmetric but should not be restricted in shape and especially in number. For example, the corrugations may also be formed into undulations of continuous arcs or ridges having only their crests rounded and valley bottoms angulated. Without any problem in the pushing operation, the corrugations may be suitably changed in design into a sawtooth shape or a square shape. Although these design changes can be acceptable, the ridges are preferred to have the continuous arc shape, because the crests are not caught when pushed by the inner face of the element so that the smooth push can be expected.

The gas sensor of the invention should not be limited to the embodiments thus far described. The structure and construction of the gas sensor can be modified in design so long as they do not deviate from the gist of the invention. The gas sensor has been embodied by the oxygen sensor in the embodiments but can also be embodied by other gas sensors.

According to the gas sensor of the first aspect of the invention, both the two side end portions, as confronting each other through the cut opening, of the terminal fitting are formed into not the straight line but the symmetric corrugations. When the terminal fitting is pushed together with the heater into the hollow portion of the element, the initial load at the push starting time is relatively high but does not make nay large change till the insertion ending time, so that the maximum force (or load) necessary for the insertion can be reduced. Moreover, the two side end portions are formed into the transversely symmetric corrugations so that the terminal fitting can be pushed without any transverse deviations in the pushing procedure. Therefore, the heater can be correctly pushed in the direction to intersect with the center axis of the hollow portion of the element. According to the gas sensor of the invention, when the conductive portion of the terminal fitting is pushed into the hollow portion of the element, the pushing force can be reduced, and the conductive portion can be prevented during and after the pushing procedure from being inclined transversely across the cut opening. As a result, the heater can be pushed correctly in the direction to intersect with the center axis of the hollow portion of the element without being inclined transversely across the opening.

As defined in the second aspect of the invention, moreover, the heater pushing portions to be connected with the conductive portion of the terminal fitting are formed to push the heater onto the inner wall face of the detecting element in a direction joining the cut opening and the opposite side across the axis, as viewed in the axial direction. In addition to the effects of the first aspect of the invention, the heater can be correctly pushed in the direction joining the opening and the opposite side across the axis, as viewed in the axial direction of the conductive portion. In case, therefore, there is adopted a design in which the heater is pushed onto the inner wall face of the element by using the terminal fitting (i.e., the heater pushing portions), the heater can be pushed highly precisely onto the target position in the inner wall face of the detecting element. As a result, it is possible to efficiently provide a gas sensor which hardly causes individual dispersions among the temperature rising rates of the elements.

In order to reduce the pushing resistance to the hollow portion of the element of the terminal fitting, each of ridges of the corrugations may have a crest having an arcuate shape, as defined in the third aspect of the invention.

In order to facilitate the push of the conductive portion of the terminal fitting into the hollow portion of the element, the terminal fitting is preferred to have such a notch on the side opposite to the cut opening across the axis, as viewed in the axial direction, as is cut from the end side positioned on the deep side of the hollow portion, and the notch has a substantially constant width toward the rear end side. By providing such notch, it is possible to reduce the insertion resistance of the terminal fitting at the insertion starting time. According to the definition of the fourth aspect of the invention, the notch can enhance the strength of the deep portion of the conductive portion so that the heater can be stably pushed onto the inner wall face of the element. According to the definition of the fifth aspect of the invention, on the other hand, the push of the terminal fitting into the hollow portion of the element can be effectively smoothed.

The entire disclosure of each and every foreign patent application from which the benefit of foreign priority has been claimed in the present application is incorporated herein by reference, as if fully set forth.

1. A gas sensor comprising:
a detecting element having a hollow cylinder shape including a closed leading end, the detecting element including a hollow portion and an electrode layer on an inner wall face of at least the hollow portion;
a terminal fitting including a cylindrical conductive portion, wherein the cylindrical conductive portion is arranged in the hollow portion, when being pushed into the hollow portion, to be electrically connected with the electrode layer; and
a rod-shaped heater for heating the detecting element, the rod-shaped heater being arranged in the hollow portion through the inside of the cylindrical conductive portion,
wherein the cylindrical conductive portion of the terminal fitting has a cylindrical shape, in which the cylindrical shape has a cut opening in a side portion of the cylindrical shape, the cut opening being along an axial direction of the conductive portion, and wherein the cylindrical conductive portion of the terminal fitting comprises at least one heater pushing portion for pushing the rod-shaped heater in a direction to intersect with a center axis of the hollow portion, the said at least one heater pushing portion being at a deeper position than an end portion of the cylindrical conductive portion that is positioned adjacent to a deep side of the hollow portion, and
wherein the terminal fitting comprises left and right side end portions across the cut opening, in which the left and right side end portions comprise respective corrugations having at least one recess and at least one ridge at each of the left and right side end portions, the corrugations being provided generally symmetrically transversely across the cut opening.

2. A gas sensor according to claim 1,
wherein said at least one heater pushing portion is provided to push the rod-shaped heater onto an inner wall face of the detecting element in a direction joining the cut opening and the opposite side across the center axis, as viewed in an center axial direction of the hollow portion.

3. A gas sensor according to claim 1,
wherein each of ridges of the corrugations comprises a crest having an arcuate shape.

4. A gas sensor according to claim 1,
wherein the terminal fitting comprises such a notch on a side opposite to the cut opening across the center axis, as viewed in an axial direction of the hollow portion, as is cut from an end side positioned on the deep side of the hollow portion, and
wherein the notch has a substantially constant width toward an rear end side, the rear end side being opposite to the deep side, and has a bottom recessed into one of a U-shape and an arcuate shape.

5. A gas sensor according to claim 1,
wherein the terminal fitting comprises such a notch on a side opposite to the cut opening across the center axis, as viewed in an axial direction of the hollow portion, as is cut from an end side positioned on the deep side of the hollow portion, and
wherein the notch comprise a portion diametrally reduced toward an rear end side, the rear end side being opposite to the deep side.

6. A gas sensor according to claim 1,
wherein the cylindrical shape of the conductive portion is formed by bending a metal sheet having a spring property.
